(19) United States
(12) Patent Application Publication
(10) Pub. No.: US 2014/0343726 A1
(43) Pub. Date: Nov. 20, 2014

(54) Machine for Selling Precious Metals and Method of Use Thereof

(71) Applicants: Raymond E. Berry, Louisville, KY (US); Michael D. Prindle, Louisville, KY (US)

(72) Inventors: Raymond E. Berry, Louisville, KY (US); Michael D. Prindle, Louisville, KY (US)

(21) Appl. No.: 14/331,064

(22) Filed: Jul. 14, 2014

Related U.S. Application Data
(60) Provisional application No. 61/823,077, filed on May 14, 2013.

(51) Int. Cl. G07F 9/02

(52) U.S. Cl. CPC G07F 9/026
USPC 700/236

(57) ABSTRACT

A machine is used for selling precious metals. The precious metals include gold, silver and the like. The precious metals could be either in a form of bullion coin or a bullion coin embedded into a plastic card for the purpose of protection. The machine contains a shell, a frame, a payment validation system, a display panel, a selection panel, a storage system, a dispensing system, a controller, a stock checking system and a security system. The machine is capable of selling gold and silver bullion coins at selling prices that are directly linked to the real time gold and silver prices traded on the commodity market. Such prices can be remotely updated via a wired or wireless connection. The security system protects the machine and functions as deterrence to potential robbers.

The current application claims a priority to the U.S. Provisional Patent Application Ser. No. 61/845,836, filed on Jul. 12, 2013. The current application is filed on Jul. 14, 2014, while Jul. 12, 2014 was on a weekend.

### FIELD OF THE INVENTION

The present invention relates generally to currency exchange based on the gold standard. More specifically, the present invention is a vending machine that dispenses gold and silver bullion coin embedded cards that are of equal monetary value to what a customer pays.

### BACKGROUND OF THE INVENTION

Due to inflation and the fluctuation in the security market, investment in precious metals such as gold, silver, and platinum has become an increasingly popular approach for people to preserve the value of their hardly earned money or even receive a gain in value. Among these investable previous metals, gold is always the most popular one people like to invest or save.

In particular, gold bullion is the most popular form of investment with several forms of investment available. Two of the most common forms of bullion are bars and coins that are priced according to their fine weight as well as supply and demand for the precious metal. In some countries, the bullion is bought and sold at major banks as well as through bullion dealers. The present invention seeks to provide an alternative means of providing consumers with gold bullion.

The present invention is a vending machine containing gold and silver bullion coin embedded cards. The vending machine is designed to accept both cash and payment cards and dispenses an equivalent amount of gold or silver bullion coin. In this way, a consumer is able to purchase gold of a guaranteed quality from a specific vending machine. It is not only easy and convenient, but also cost saving, as a majority of the overhead costs for brick and mortar store and labor would be saved.

### BRIEF DESCRIPTION OF THE DRAWINGS

FIG. 1 is an illustration of front side of the machine for selling gold and silver bullion coins.

FIG. 2 is an illustration of internal components of the interior of the machine for selling gold and silver coins.

FIG. 3 is an illustration of external components of the interior of the machine for selling gold and silver coins.

FIG. 4 is a view of the gold bullion coins sealed in a transparent plastic card.

FIG. 5 is a view of the silver bullion coin.

### DETAIL DESCRIPTIONS OF THE INVENTION

All illustrations of the drawings are for the purpose of describing selected versions of the present invention and are not intended to limit the scope of the present invention.

The present invention is a vending machine that dispenses gold or silver bullion embedded cards. The bullion embedded cards are dispensed based on total user inputted value. Users may submit payment in cash or through payment cards such as credit cards and debit cards.

The present invention comprises a heavy security steel cabinet with internal storage vault that houses a plurality of gold or silver bullion embedded cards. A payment system is present on the front vending machine and users are able to input a desired value using cash or a payment card such as a credit card or debit card. Banknotes are accepted through a paper currency slot located on the front side of the vending machine.

Alternatively, users may insert, swipe, or manually key in payment card information on a credit card terminal. Following payment, users are able to select the type of bullion (gold or silver) that they desire. Gold or silver bullion embedded cards are dispensed from the machine's internal storage vault in the equivalent amount of user inputted payment. The vending machine is secured by means of non-drillable locks and a heavy steel frame that greatly hinder attempts to compromise the cabinet and internal storage vault.

Furthermore, the vending machine features an integrated security system with a number of measures that complement the locks and heavy frame of the vending machine. The security measures may include, but are not limited to, an internal camera, an external camera, a motion sensor system, a vibration sensor, audio/visual alarms, and 24 hour security monitoring, if needed.

In the preferred embodiment of the present invention, bullion embedded cards are dispensed containing one gram coins. As a result, payments are taken in increments corresponding to the value of the coins. However, in alternative embodiments of the present invention, the vending machine may dispense varying amounts of bullion based on corresponding user inputted value.

As a specific vending machine for selling gold bullion coin, the present invention has a shell, a payment validation system, display and selection panels, a bullion coin storage system, a bullion dispersing system, a control system, a communication system, a bullion stock checking system, a receipt providing device, a security system, as well as gold and silver bullion coin embedded cards.

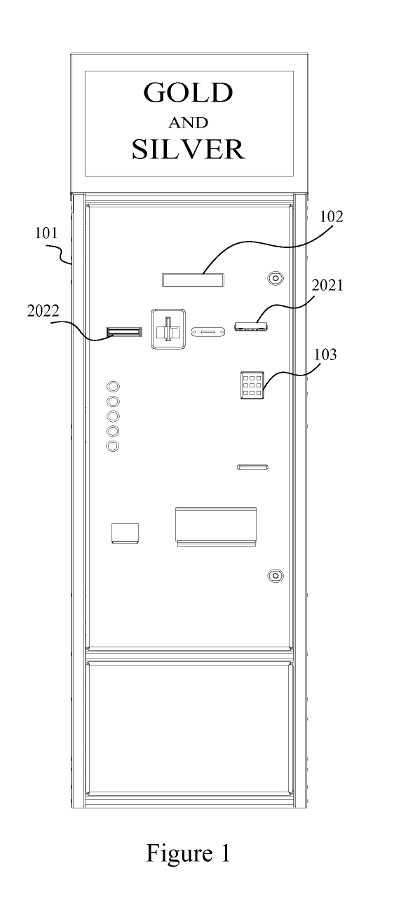

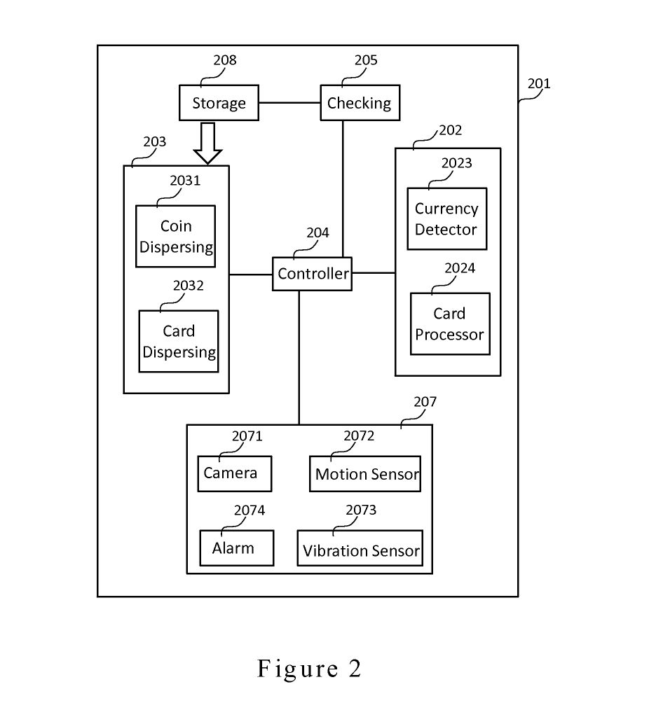

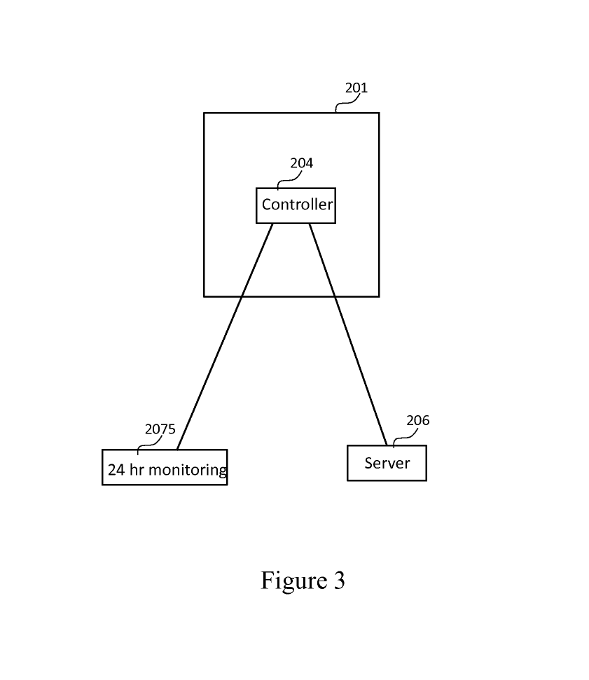

In reference to FIGS. 1 to 3, the shell 101 is the most outer part of the present invention. Since what has been stored in the machine is gold and silver, which are highly desired precious metals; and the shell of the machine is the first defense of the machine, the shell is made of heavy duty steel or other security materials. In this way, it is able to withstand tampering as well as break-in attempts. In addition, the machine also has a strong and heavy frame 201, which not only provides a reliable support for the entire structure of the machine, but also provides stability to the machine.

The cabinet is approximately rectangular and comprises a front side, a rear side, and a hinged door. The cabinet further comprises an internal storage vault. The internal storage vault is accessed by means of a hinged door located on the front side of the cabinet. The hinged door is secured by means of multiple non-drillable locks in order to hinder attempts at compromising the internal storage vault.

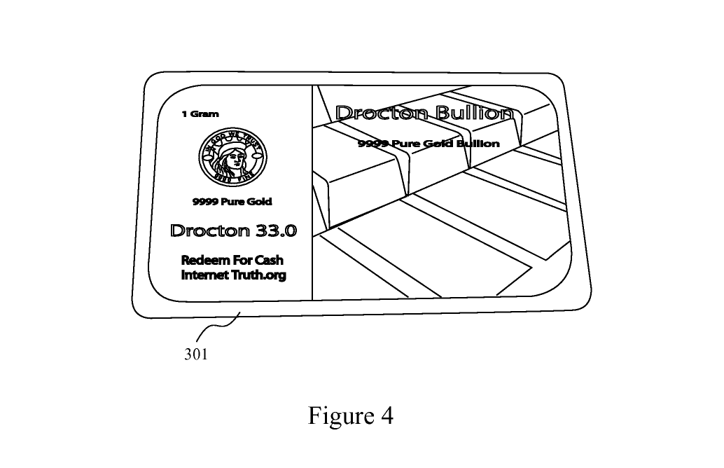

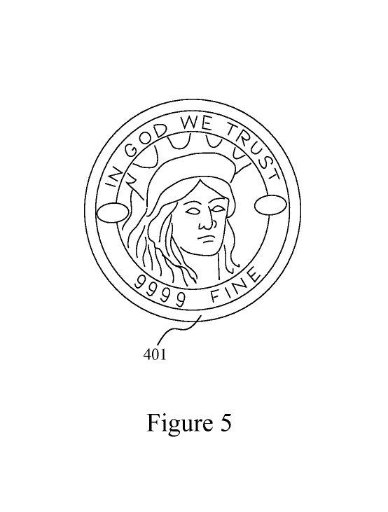

In reference to FIGS. 4 and 5, the gold and silver bullion coins are stored in internal storage vault. In one embodiment of the present invention, the gold bullion is made in bullion coin and sealed in a specific transparent plastic card 301. In this way, the gold bullion coin received a good protection against scratch, dirt and other potential damages. The denominations of the gold bullion coin may be one gram and one tenth of an ounce. However, it is also noted that other suitable denominators of good bullion coin can also be provided for the machine. On the other hand, the silver is in a form of bullion coin 401, and not sealed in a plastic card. The denomination of the silver bullion coin is one gram or one half of an ounce. And as mentioned previously, any other suitable denomination could be provided for the machine of the present invention. Furthermore, other precious metals, such as platinum, can also be sold by the machine, in either a forms of a bullion coin embedded in a plastic card, or in a form of a bullion coin. The card, in its preferred embodiment, is fully laminated in order to seal the embedded gold or silver bullion within the card slot. Other types of cards comprising of different materials such as plastic or other cardstock can be used as well. The front side and rear side of the card may be cosmetically and aesthetically customized based on user needs and/or preferences.

The vault or storage system 208 has been made of strong material to ensure the security of the gold and silver bullion coins store in it. In addition, since the silver bullion coin is not sealed. There are soft inner liners for the bullion coin storage, especially for the storage vault for the silver bullion coin.

The machine comprises a payment validation system 202. On front side of the machine, there are two terminals of the payment validation system. One is a slot for cash payment 2021, the other one is a card reader 2022 for card payment, such as credit card, debit card and etc. The payment validation system also includes a currency detector 2023, which is connected to the slot for cash; and a credit card processing device 2024 which is connected to the card reader. In addition, both the currency detector and the credit card processing device are connected to a central controller. The payment information then would be transmitted to the central controller to direct further actions of the machine. In the case when cash is used as payment and the type and quantity of the ordered bullion coin(s) have been selected by a customer, the controller 204 would be able to make the calculation and send the exact change out to the customer.

On the same front side of the machine, there is also a display panel 102, which displays the information of the gold and silver bullion coins available for purchase from the machine. Such information includes the type of bullion coins are available, each bullion's quality and weight, as well as their respective prices. In addition, there is also a selection panel 103 which allows a user to select the type of bullion coin(s) he or she wants to order, as well as the quality of each type of bullion coin to be ordered. The selection panel may be a touch panel. In this case, it may be one piece of touch panel for both displaying and selection. Alternatively, the selection panel may be a traditional key board selection panel. As for the credit card processing, users may swipe, insert, or manually key in payment card information during a transaction.

The bullion coin dispersing system 203 comprising a coin dispersing mechanism 2031 and a card dispersing mechanism 2032, which are responsible for dispersing the silver coin and gold coin embedded card, respectively. These two dispersing mechanisms are connected and controlled by the controller 204, respectively. After receiving the purchase information from the selection panel and payment validation system, the central controller will send a signal to direct one of the dispersing mechanism to dispersing what a user purchased through either a slot for coin or a slot for coin card.

As mentioned before, all of the purchasing and payment information will be transferred to the central controller first, then the central controller would determination of the type of coin or coin embedded card and quantity of the respected card should be dispersed to a customer.

Moreover, there would be a bullion stock checking system 205, which is connected to the central controller. The bullion stock checking system comprises a coin stock detector and a card stock detector. A predetermined quantity of coin or coin card stock has been set up. In this case, whenever the coin stock or the card stock in a machine is lower than the predetermined quantity, the detector will send a message to the central controller to inform about the low stock. After receiving the information, the central controller will send a message to a main server 206, an operator or both of them to request for a restock.

One important aspect of the present invention is the prices of gold and silver coin are remotely set and are capable of being linked to the real time gold and silver prices currently traded on the commodity market. This has been realized by the cooperation among the central controller, communication system, remotely located main server, as well as the displaying device. The main server is able to either monitor or receive the current gold and silver prices. Based on the real time prices of gold and silver, the main server will calculate the selling price of the gold and silver bullion coins in the machine will be determined. Next, the price information would be sent to the central controller, which subsequently, the price information will be displayed on the displaying panel. Accordingly, the next purchase will be processed based on the newly updated selling price. Further, the time period of how frequently the gold and silver coin price would be updated can be set up by the server or an operator. It could be from a few minutes to a few weeks. On the other hand, the price of the gold and silver bullion coins can be set manually by an operator.

The present invention also features a security system with a number of measures that, in conjunction with the locks and heavy duty shell and heavy frame of the vending machine, hinders unauthorized tampering as well as attempts at theft and break-ins. In addition, the present invention is not limited with respect to the exact security measures implemented in the system. The security system 207 provides an additional layer of deterrent beyond that which is provided by the locks and heavy frame of the vending machine. Security features may include, but are not limited to: internal and /or external cameras 2071, motion sensor 2072, vibration sensor 2073, Audio and visual alarms 2074, and 24 hour security monitoring 2075.

When a customer is going to purchase a bullion coin, the present invention is used by inserting banknotes into the paper currency slot. Alternatively, the user may insert, swipe, or manually key in payment card information through the credit card terminal. After payment has been processed, the user may select the type of bullion (gold or silver), and type of coin that he or she desires to order. The purchase information and the payment information will be sent to the central controller. After determining that the purchase is valid, the controller will direct the respective dispensing mechanism to send the bullion coin in the ordered quantity to the respective dispensing slot, from where the customer will receive his or her purchase. At the same time, a receipt printing device will print a receipt for the consumer.

Although the present invention has been explained in relation to its preferred embodiment, it is understood that many other possible modifications and variations can be made without departing from the spirit and scope of the present invention.

What is claimed is:

1. A machine for selling precious metals, comprising
a shell;
a frame;
a payment validation system;
a display panel;
a selection panel;
a storage system;
a dispensing system;
a controller;
a stock checking system;
a security system;
said frame support said shell;
said payment validation system, said display panel, said selection panel being connected to said controller;
said storage panel storing said previous metals;
said dispensing system being connected to said controller and being directed by said controller to disperse a customer's valid purchase from said machine;
said stock checking system being connected to said controller and reporting low stock information to said controller; and
said security system being connected to said controller and sending security information to said controller.

2. The machine for selling precious metals as claimed in claim 1, comprising
said previous metals comprising gold, silver, platinum.

3. The machine for selling precious metals as claimed in claim 2, comprising
said previous metals being in a form of bullion coin, or
said previous metals being in a form of a bullion coin sealed in a plastic card.

4. The machine for selling precious metals as claimed in claim 1, comprising
said payment validation system comprising a cash insert slot and a currency detector, and a card reader;
said currency detector being connected to said cash insert slot;
said card reader processing a payment made by a payment card; and
said payment card comprising credit card, debit card, bank card.

5. The machine for selling precious metals as claimed in claim 1, comprising
said selection panel allowing a customer to input a code corresponding to a product of said precious metals; and
said selection panel being a touch panel or a keyboard panel.

6. The machine for selling precious metals as claimed in claim 1, further comprising
a communication system; and
said communication system being a wired communication system or a wireless communication.

7. The machine for selling precious metals as claimed in claim 6, comprising
said communication system being connected to said controller;
said communication system being connected to remotely located main server;
said main server receiving real time trading prices of said precious metals;
for a predetermined time interval, said main server calculating new selling prices of said precious metals in said machine according to said real time trading prices of said precious metals; and
said main server sending said new real time trading prices of said precious metals to said controller of said machine.

8. The machine for selling precious metals as claimed in claim 1, comprising
said stock checking system comprising a detector;
said detector detecting a quantity of said precious metals in said storage system of said machine; and
said detector sending a low stock signal to said control system when the detected quantity is lower than a predetermined low stock threshold.

9. The machine for selling precious metals as claimed in claim 1, said security system comprising:
non-drillable locks, wherein said non-drillable locks secure said storage system;
an internal camera;
an external camera;
a motion sensor;
a vibration sensor;
an alarm; and
a 24 hour security monitoring, wherein
said internal and external cameras, said motion and vibration sensors, said alarm being connected to said controller; and
said internal and external cameras and said alarm being connected to said 24 hour security monitoring.

10. The machine for selling precious metals as claimed in claim 1, further comprising:
a receipt providing system;
said receipt providing system printing a receipt to a customer when a transaction has been finished.

11. A method for selling precious metals with a machine, comprising:
displaying current selling prices for said precious metal;
receiving a payment from a customer;
validating said payment;
promoting said customer to select one or multiple precious metal products and quantity of each selected precious metal product;
processing information about said payment and said selected one or multiple precious metal products and quantity of each selected precious metal product;
dispensing the selected precious metal products; and
printing a receipt for said customer.

12. The method for selling precious metals with a machine as claimed in claim 11, said step of validating said payment comprising:
validating a cash payment with a currency detector;
validating a card payment with a card reader, wherein said card payment comprising credit card, debit card and bank card; and
returning said cash payment or card payment to said customer if said cash payment or card payment is determined to be invalid.

13. The method for selling precious metals with a machine as claimed in claim 11, further comprising
monitoring real time prices of said precious traded on a commodity market;
calculating new selling prices of said precious metals based on said real time prices; and
displaying said new selling prices of said precious metals on said machine.

14. The method for selling precious metals with a machine as claimed in claim 11, further comprising
using cameras to monitor a security situation of said machine;
sending said security situation to a 24 hours monitoring system; and
making alarms when an abnormal security situation occurs.

15. A machine for selling precious metals, comprising
a shell;
a frame;
a payment validation system;
a display panel;
a selection panel;
a storage system;
a dispensing system;
a controller;
a stock checking system;
a security system;
a receipt providing system;
said receipt providing system printing a receipt to a customer when a transaction has been finished;
said frame support said shell;
said payment validation system, said display panel, said selection panel being connected to said controller;
said storage panel storing said previous metals;
said dispensing system being connected to said controller and being directed by said controller to disperse a customer's valid purchase from said machine;
said stock checking system being connected to said controller and reporting low stock information to said controller; and
said security system being connected to said controller and sending security information to said controller.

16. The machine for selling precious metals as claimed in claim 15, comprising
said previous metals comprising gold, silver, platinum; and
said previous metals being in a form of bullion coin, or
said previous metals being in a form of a bullion coin sealed in a plastic card.

17. The machine for selling precious metals as claimed in claim 15, comprising
said payment validation system comprising a cash insert slot and a currency detector, and a card reader;
said currency detector being connected to said cash insert slot;
said card reader processing a payment made by a payment card; and
said payment card comprising credit card, debit card, bank card.

18. The machine for selling precious metals as claimed in claim 15, comprising
said selection panel allowing a customer to input a code corresponding to a product of said precious metals; and
said selection panel being a touch panel or a keyboard panel.

19. The machine for selling precious metals as claimed in claim 15, further comprising
a communication system;
said communication system being a wired communication system or a wireless communication;
said communication system being connected to said controller;
said communication system being connected to remotely located main server;
said main server receiving real time trading prices of said precious metals;
for a predetermined time interval, said main server calculating new selling prices of said precious metals in said machine according to said real time trading prices of said precious metals; and
said main server sending said new real time trading prices of said precious metals to said controller of said machine.

20. The machine for selling precious metals as claimed in claim 15, comprising
said stock checking system comprising a detector;
said detector detecting a quantity of said precious metals in said storage system of said machine;
said detector sending a low stock signal to said control system when the detected quantity is lower than a predetermined low stock threshold;
non-drillable locks, wherein said non-drillable locks secure said storage system;
an internal camera;
an external camera;
a motion sensor;
a vibration sensor;
an alarm; and
a 24 hour security monitoring, wherein
said internal and external cameras, said motion and vibration sensors, said alarm being connected to said controller; and
said internal and external cameras and said alarm being connected to said 24 hour security monitoring.
